(19) United States
(12) Patent Application Publication
(10) Pub. No.: US 2017/0337376 A1
(43) Pub. Date: Nov. 23, 2017

(54) Adaptive Heuristic Behavioral Policing of Executable Objects

(71) Applicant: Scot Anthony Reader, Boulder, CO (US)

(72) Inventor: Scot Anthony Reader, Boulder, CO (US)

(21) Appl. No.: 15/159,319

(22) Filed: May 19, 2016

(51) Int. Cl. G06F 21/56

(52) U.S. Cl. CPC G06F 21/563; G06F 21/568; G06F 2221/033

(57) ABSTRACT

Methods and systems for heuristic behavioral policing of executable objects dynamically adapt based on context to reduce false positive and false negative outcomes. The level of heuristic behavioral suspicion required to subject an inbound executable object to a policing action is determined by an adaptive suspicion threshold. The suspicion threshold is dynamically adjusted based on outcomes of processing recent executable objects. The invention recognizes that malware often arrives in waves, such as during a concerted attack on a network or an endpoint, so that dispositions of recent executable objects provide useful context for suspicion threshold adjustment.

### BACKGROUND OF THE INVENTION

The present invention relates to network security and, more particularly, proactively protecting networks from zero-day malware.

Modern network security solutions provide both reactive and proactive policing of malicious executable objects, often called malware. Reactive policing is typically provided by malware signature scanners, which detect hashes and strings in executable objects that have previously been confirmed to be malicious and subject such objects to policing actions. Proactive policing is typically provided by heuristic behavioral scanners, which scan code structures or operations of executable objects, classify objects whose code structures or operations surpass a threshold degree of suspiciousness as malicious, and subject such objects to policing actions.

Heuristic behavioral scanners have the advantage over malware signature scanners of providing protection against new and unknown malware, often called zero-day malware, for which signatures do not yet exist. However, heuristic behavioral scanners have the disadvantage of basing policing decisions on probabilities and thresholds. As such, they are susceptible to “false positive” outcomes which result in benign executable objects being subjected to policing actions and “false negative” outcomes which result in malicious executable objects skirting policing actions.

What is needed is a heuristic behavioral policing technique for executable objects that reduces false positive and false negative outcomes.

### SUMMARY OF THE INVENTION

The present invention provides a heuristic behavioral policing method and system for executable objects that dynamically adapts based on context to reduce false positive and false negative outcomes. In the method and system, the level of heuristic behavioral suspicion required to subject an inbound executable object to a policing action is determined by an adaptive suspicion threshold. The suspicion threshold is dynamically adjusted based on outcomes of processing recent executable objects. The invention recognizes that malware often arrives in waves, such as during a concerted attack on a network or an endpoint, so that processing outcomes for recent executable objects provide useful context for suspicion threshold adjustment. More particularly, if recently processed executable objects have raised high suspicion, there is a heightened risk of false negative outcomes and more aggressive policing of inbound executable objects is warranted. On the other hand, if recently processed executable objects have raised low suspicion, there is a heightened risk of false positive outcomes and more relaxed policing of inbound executable objects is warranted.

In one aspect of the invention, a computer-implemented executable object policing method comprises receiving an executable object from a network; obtaining a suspicion value for the executable object, wherein the suspicion value is generated based on heuristic behavioral scanning and represents a potential for maliciousness of the executable object; comparing the suspicion value with a suspicion threshold; subjecting the executable object to a policing action if the comparison indicates that the suspicion value violates the suspicion threshold; and dynamically adjusting the suspicion threshold based on an outcome of processing the executable object.

In some embodiments, the dynamically adjusting step comprises updating an attack risk indicator based on the processing outcome and updating the suspicion threshold based on the attack risk indicator.

In some embodiments, the executable object is an executable file.

In some embodiments, the executable object is a web page containing executable script.

In some embodiments, the heuristic behavioral scanning comprises detecting suspicious operations performed by the executable object.

In some embodiments, the heuristic behavioral scanning comprises detecting suspicious program code structures in the executable object.

In some embodiments, the suspicion value and the suspicion threshold comprise numbers selected from a predetermined domain of at least three numbers.

In some embodiments, the suspicion value and the suspicion threshold comprise levels selected from a predetermined group of at least three levels.

In some embodiments, the suspicion value is obtained by subjecting the executable object to the heuristic behavioral scanning in real-time.

In some embodiments, the suspicion value is obtained by retrieving the suspicion value from a data store using a hash value for the executable object.

In some embodiments, the policing action comprises one or more of discarding the executable object, quarantining the executable object, logging a security event regarding the executable object or outputting a security alert regarding the executable object.

In some embodiments, the method further comprises forwarding the executable object to a destination without subjecting the executable object to the policing action if the comparison indicates that the suspicion value does not violate the suspicion threshold.

In another aspect of the invention, a computing device comprises a memory configured to store a suspicion threshold; a network interface configured to receive an executable object; and a processor communicatively coupled with the memory and the network interface and configured to obtain a suspicion value for the executable object, wherein the suspicion value is generated based on heuristic behavioral scanning and represents a potential for maliciousness of the executable object, wherein the processor is further configured to compare the suspicion value with the suspicion threshold and, if the comparison indicates that the suspicion value violates the suspicion threshold, subject the executable object to a policing action, the processor being further configured to dynamically adjust the suspicion threshold based an outcome of processing the executable object.

In some embodiments, the computing device comprises a web gateway.

In some embodiments, the computing device comprises a web client.

In yet another aspect of the invention, an executable object policing system comprises a first computing device configured to receive an executable object from a network, obtain a suspicion value for the executable object, wherein the suspicion value represents a potential for maliciousness of the executable object, compare the suspicion value with a suspicion threshold and, if the comparison indicates that the suspicion value violates the suspicion threshold, subject the executable object to a policing action, the first computing device being further configured to dynamically adjust the suspicion threshold based on an outcome of processing the executable object; and a second computing device communicatively coupled with the first computing device and configured to generate the suspicion value based on heuristic behavioral scanning and provide the suspicion value to the first computing device.

In some embodiments, the first computing device comprises a web gateway and the second computing device comprises a cloud server.

In some embodiments, the first computing device comprises a web client and the second computing device comprises a cloud server.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a perimeter security system in embodiments of the invention.

FIG. 2 shows the web gateway of FIG. 1 in more detail.

FIG. 3 shows the web gateway processor of FIG. 1 in more detail.

FIG. 4 shows the web gateway memory of FIG. 1 in more detail.

FIGS. 5 and 6 show a computer-implemented method for policing executable objects in embodiments of the invention.

FIG. 7 shows a functional relationship between an attack risk indicator and a suspicion threshold in one example.

FIG. 8 shows an endpoint security system in embodiments of the invention.

### DETAILED DESCRIPTION OF A PREFERRED EMBODIMENT

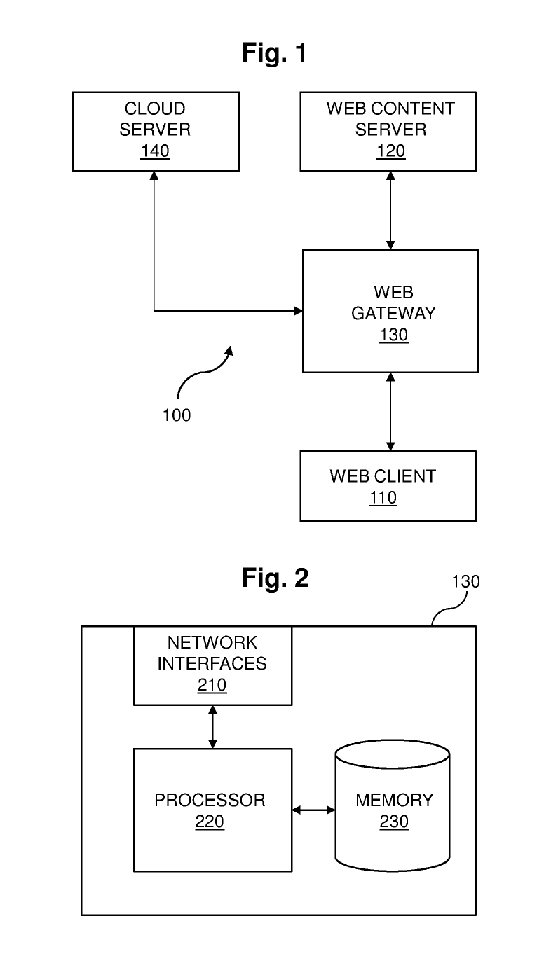

FIG. 1 shows a perimeter security system 100 for a computer network in embodiments of the invention. Perimeter security system 100 includes a web gateway 130 located at the edge of a protected network between a web client 110 inside the protected network and a web content server 120 outside the protected network. Web gateway 130 protects web client 110 from malicious executable objects transmitted by web content server 120 and destined for web client 110. In providing this protection, web gateway 130 consults a cloud server 140 which returns suspicion values to web gateway 130 that are applied by web gateway 130 in determining whether to subject executable objects to policing actions, such as discard, quarantine and alert actions. Cloud server 140 generates the suspicion values by performing heuristic behavioral scanning of executable objects. In embodiments of the invention, web gateway 130 provides protection to many web clients within the protected network from many web content servers in the Internet. In embodiments of the invention, cloud server 140 is located outside the protected network.

Web client 110 is an endpoint computing device, such as a personal computer, tablet computer, smartphone or file server. Web client 110 requests digital content from web content server 120 through web gateway 130. Requested digital content may include, for example, web pages, email messages, applications, files and documents. Some requested digital content consists in or includes executable objects having program instructions that can execute on web client 110, such as scripts embedded in web pages (e.g. Javascript) or executable files (e.g. PE files) attached to email messages. If not blocked by web gateway 130, some of these executable objects can perform malicious actions on web client 110, such as assuming control of web client 110 or stealing or destroying data on web client 110. These malicious actions may be performed entirely by the initially received executable object or in conjunction with other executable objects downloaded or dynamically created by the initial executable object on web client 110. Executable objects having program instructions that when executed perform or facilitate malicious actions on a web client are referred to herein as malware.

Cloud server 140 is a cloud computing device that provides suspicion values for executable objects at the request of other computing devices, including web gateway 130. Cloud server 140 generates suspicion values by performing heuristic behavioral scans on executable objects. Suspicion values represent the potential of executable objects for maliciousness determined at least in part through heuristic behavioral scanning. Suspicion values may be generated based on static heuristic scanning, dynamic heuristic scanning, or both. In static heuristic scanning, sometimes called passive heuristics, cloud server 140 scans code structures of an executable object looking for matches with predetermined rules of structural suspicion. These matches are scored to compute a static suspicion value for the executable object. In dynamic heuristic scanning, sometimes called active heuristics, cloud server 140 executes an executable object in a virtual computing environment, sometimes called a sandbox, and monitors operations performed by the executing object for matches with predetermined rules of operational suspicion. These matches are scored to compute a dynamic suspicion value for the executable object. Examples of code structures and operations that may be addressed by rules of suspicion include those that attempt to evade detection; attempt to download, create or execute an untrusted executable object; attempt an unauthorized change to a registry, operating system or application; or attempt unauthorized access to an area of memory. In embodiments of the invention, static and dynamic suspicion values are combined, such as by averaging, to arrive at an overall suspicion value. In other embodiments, suspicion values take into account factors beyond heuristic behavior of executable objects, such as object reputations. Once generated, cloud server 140 locally stores computed suspicion values and associated hash values for executable objects to avoid having to repeat heuristic behavioral scanning on those executable objects. In some embodiments, suspicion values are numbers within a predetermined domain, such as from 0 to 100, with 0 representing minimum suspicion and 100 representing maximum suspicion. In other embodiments, suspicion values are levels selected from a predetermined group of levels, such as “low suspicion,” “medium suspicion” and “high suspicion.”

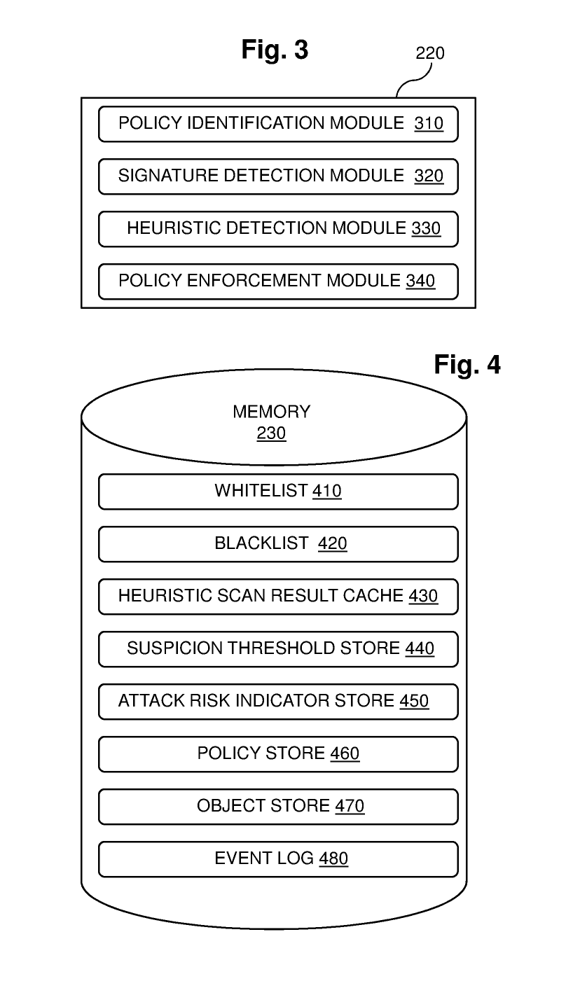

Web gateway 130 is a perimeter computing device, such as a firewall appliance or intrusion prevention (IPS) appliance. FIG. 2 shows web gateway 130 in more detail to include network interfaces 210, a processor 220 and a memory 230. Network interfaces 210 include one or more external interfaces for bidirectional communication with computing devices in the Internet, including web content server 120 and cloud server 140, and one or more internal interfaces for bidirectional communication with computing devices in the protected network, including web client 110. Network interfaces 210 receive and transmit packetized traffic in different flows and sessions. Network interfaces 210 are internally coupled to processor 220, which executes program instructions of software modules to police, using object handling data stored in memory 230, executable objects contained in inbound traffic received from computing devices in the Internet and destined for devices in the protected network, including executable objects received from web content server 120 and destined for web client 110. FIG. 3 shows software modules executed by processor 220 to include a policy identification module 310, a signature detection module 320, a heuristic detection module 330 and a policy enforcement module 340. In embodiments of the invention, custom circuitry may be instantiated on processor 220 and perform one or more functions otherwise performed by these software modules. FIG. 4 shows object handling data stored in memory 230 to include a whitelist 410, a blacklist 420, a heuristic scan result cache 430, a suspicion threshold store 440, an attack risk indicator store 450, a policy store 460, an object store 470 and an event log 480.

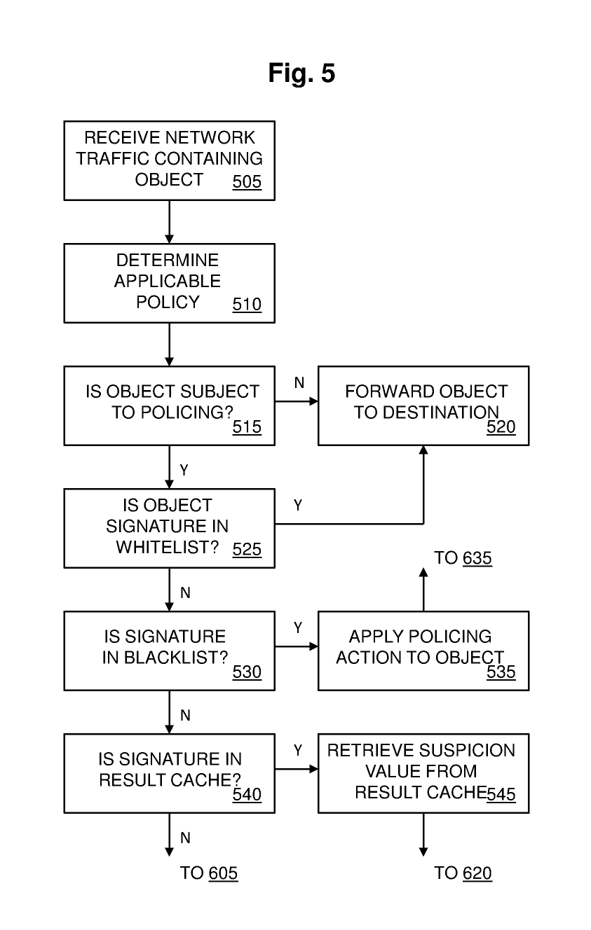

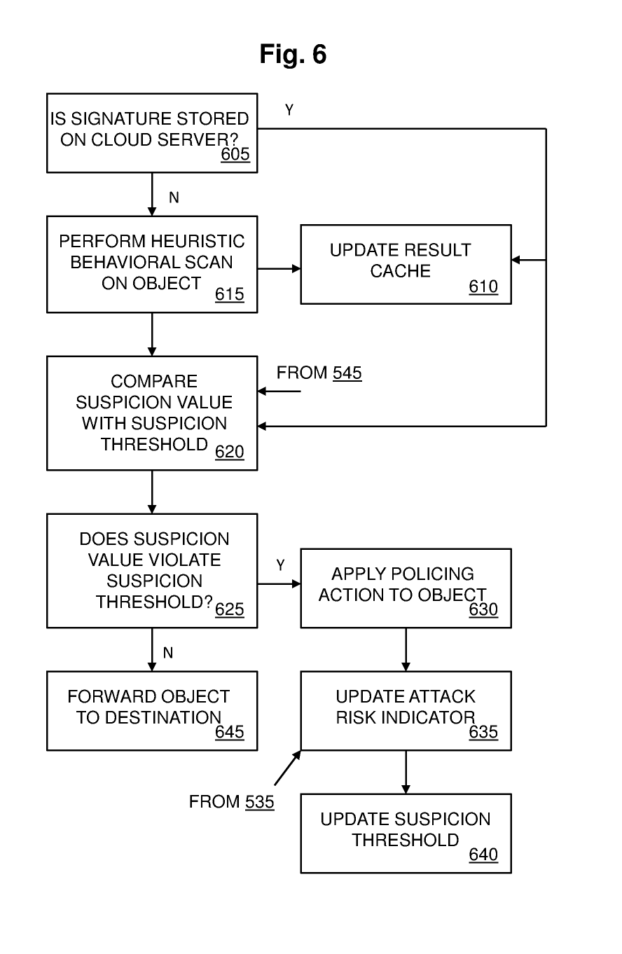

FIGS. 5 and 6 together show a computer-implemented method for adaptive heuristic behavioral policing of executable objects in embodiments of the invention. At the outset, inbound network traffic containing an executable object transmitted by web content server 120 and destined to web client 110 is received on one of network interfaces 210 (505) and relayed to processor 220. Policy identification module 310, executing on processor 220, identifies a security policy applicable to the inbound executable object (510). The security policy is determined based on characteristics of the flow or session in which the executable object is transmitted, such as an IP address, TCP port number or application layer protocol (e.g. HTTP, HTTPS, SMTP, IMAP, POP, FTP, etc.). Policy identification module 310 identifies the applicable security policy by looking up the flow or session characteristics in policy store 460 and locating a matching security policy.

Policy identification module 310 next determines from the security policy whether the inbound executable object is subject to policing (515). In this regard, the applicable security policy may indicate to exclude executable objects having certain attributes (e.g. file extension, file size, etc.) from policing. If the applicable security policy indicates that the inbound executable object is excluded from policing, web gateway 130 forwards the executable object to web client 110 on one of network interfaces 210 without subjecting the executable object to a policing action (520). On the other hand, if the applicable security policy indicates that the inbound executable object is subject to policing, policy identification module 310 invokes signature detection module 320 for further processing of the executable object.

Signature detection module 320, executing on processor 220, provides reactive protection against malware transmitted by web content server 120 and destined for web client 110. In this regard, signature detection module 320 first determines whether the inbound executable object has been whitelisted (525). Signature detection module 320 computes a hash value representing a unique signature of the inbound executable object, such as an MDS, SHA-1 or SHA-256 hash, and looks up the hash value in whitelist 410, which stores hash values of executable objects known to be benign. In embodiments of the invention, whitelist 410 also stores trusted IP addresses or URLs and signature detection module 320 further determines whether the inbound executable object is associated with a trusted IP address or URL. If a matching entry is found in whitelist 410, web gateway 130 forwards the executable object to web client 110 on one of network interfaces 210 without subjecting the executable object to a policing action (520). Otherwise, signature detection module 320 proceeds to determine whether the executable object has been blacklisted by looking up the hash value in blacklist 420, which stores hash values of executable objects known to be malicious (530). In embodiments of the invention, blacklist 420 also stores blacklisted IP addresses and URLs and signature detection module 320 further determines whether the executable object is associated with a blacklisted IP address or URL. If a matching entry is found in blacklist 420, signature detection module 320 reports the executable object as malware to policy enforcement module 340 and policy enforcement module 340 applies a policing action to the executable object based on the applicable security policy (535). Otherwise, signature detection module 320 invokes heuristic detection module 330 for further processing of the executable object.

Heuristic detection module 330, executing on processor 220, provides proactive protection against zero-day malware transmitted by web content server 120 and destined for web client 110 which evades detection by signature detection module 320. Heuristic detection module 330 first looks up the hash value of the inbound executable object in a heuristic scan result cache 430 (540). Heuristic scan result cache 430 stores hash values and associated suspicion values for executable objects recently subjected to heuristic behavioral scanning by cloud server 140 pursuant to requests from web gateway 130. If a matching cache entry is found, heuristic detection module 330 retrieves the suspicion value (545) and reports the suspicion value to policy enforcement module 340 for use in policing the executable object. Otherwise, heuristic detection module 330 queries cloud server 140 using the hash value to see if cloud server 140 subjected the executable object to heuristic behavioral scanning pursuant to a request from another computing device (605). If cloud server 140 returns a suspicion value in response to the query, heuristic detection module 330 reports the suspicion value to policy enforcement module 340 for use in policing the executable object. In that event, heuristic detection module 330 also adds an entry in heuristic scan result cache 430 associating the hash value for the executable object and the suspicion value for future use (610). On the other hand, if cloud server 140 indicates in response to the query that the suspicion value is unknown to cloud server 140, heuristic detection module 330 sends the executable object or a copy thereof to cloud server 140 for real-time heuristic behavioral scanning. Where a copy of the executable object is sent to cloud server 140, the original executable object may be sent to object store 470 for temporary storage. Cloud server 140 performs real-time heuristic behavioral scanning (615) and returns a suspicion value to heuristic detection module 330, along with the original executable object if sent to cloud server 140. Heuristic detection module 330 then reports the suspicion value to policy enforcement module 340 for use in policing the executable object. Heuristic detection module 330 also adds an entry in heuristic scan result cache 430 associating the hash value for the executable object and the suspicion value for future use (610). Entries heuristic scan result cache 430 may include a time-to-live value causing the entries to age-out of heuristic scan result cache 430 after a predetermined time.

Policy enforcement module 340, executing on processor 220, subjects executable objects transmitted by web content server 120 and destined for web client 110 to policing actions as indicated. When signature detection module 320 reports an inbound executable object as malware, policy enforcement module 340 subjects the executable object to a policing action indicated by the applicable security policy (535) without reference to the object's suspicion value. When heuristic detection module 330 reports a suspicion value for the executable object, policy enforcement module 340 conditionally subjects the executable object to a policing action indicated by the applicable security policy depending on whether the suspicion value violates the suspicion threshold stored in suspicion threshold store 440. More particularly, policy enforcement module 340 retrieves the suspicion threshold from suspicion threshold store 440 and compares the reported suspicion value for the executable object with the suspicion threshold (620). Policy enforcement module 340 determines whether the suspicion value violates the suspicion threshold based on the comparison (625). In embodiments of the invention, the suspicion value violates the suspicion threshold if the suspicion value is a higher number or level than the suspicion threshold, and does not violate the suspicion threshold if it is a lower number or level than the suspicion threshold. If the suspicion value does not violate the suspicion threshold, web gateway 130 forwards the executable object to web client 110 on one of network interfaces 210 without subjecting the executable object to a policing action (645). On the other hand, if the suspicion value violates the suspicion threshold, policy enforcement module 340 subjects the executable object to a policing action indicated by the applicable security policy (630).

Policy enforcement module 340, in subjecting an inbound executable object to a policing action arising from signature or heuristic detection, consults policy store 460 to determine one or more policing actions configured for the applicable security policy and subjects the executable object to the one or more policing actions. Configured policing actions may include, without limitation, discarding the executable object, quarantining the executable object in object store 470, logging a security event regarding the executable object in event log 480 or outputting a security alert regarding the executable object to a remote network management console or web client 110.

Policy enforcement module 340 also dynamically adjusts the suspicion threshold based on an outcome of processing the inbound executable object. In this regard, policy enforcement module 340 first updates an attack risk indicator stored in attack risk indicator store 450 based on an outcome of processing the inbound executable object (635). Policy enforcement module 340 then updates the suspicion threshold stored in suspicion threshold store 440 based on the updated attack risk indicator (640). In embodiments of the invention, the attack risk indicator represents a frequency with which inbound executable objects processed by web gateway 130 in a recent time interval of predetermined duration have been subjected to policing actions based on signature or heuristic detection. In these embodiments, the processing outcome used to update the attack risk indicator is the fact of whether the executable object was subjected to a policing action. In other embodiments of the invention, the attack risk indicator represents an average suspicion value for inbound executable objects in a recent time interval of predetermined duration. In these embodiments, the processing outcome used to update the attack risk indicator is the suspicion value obtained for the executable object. In these embodiments, Step 635 may be performed on all inbound executable objects for which suspicion values are obtained, regardless of whether they violate the suspicion threshold. In still other embodiments, the attack risk indicator represents a time-weighted detection frequency or time-weighted average suspicion value, with more recent detections or suspicion values assigned greater weight in the representation. In embodiments of the invention, the attack risk indicator is normalized to a value between 0 and 100.

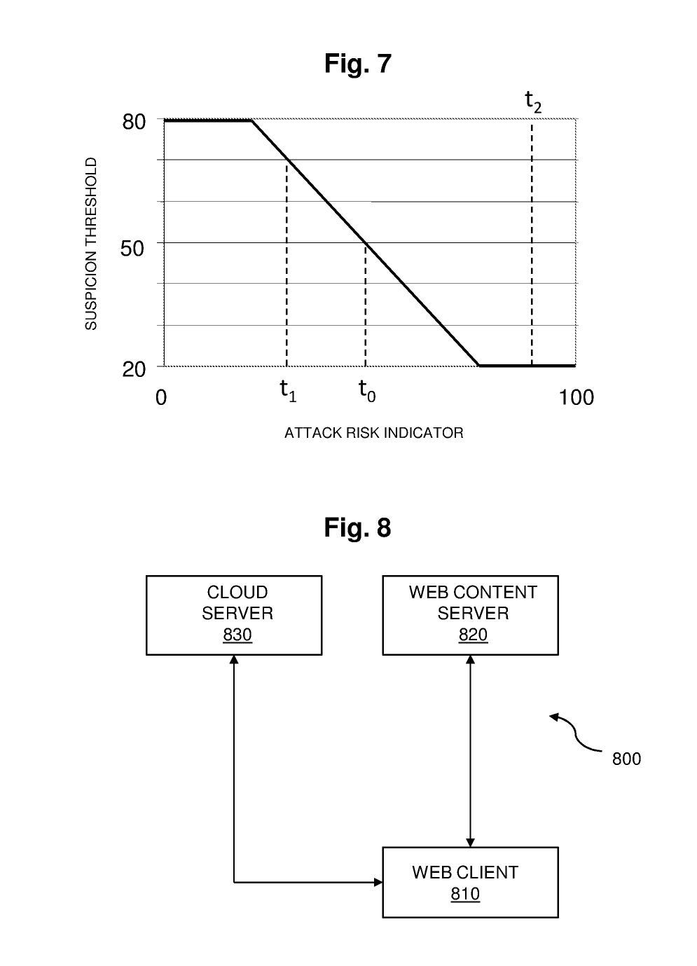

Dynamic updating of the suspicion threshold will now be described by reference to FIG. 7 in one example. In this example: (1) suspicion values for executable objects range from 0 to 100, with 0 being least suspicious (i.e. benign) and 100 being most suspicious (i.e. malicious); (2) the suspicion threshold ranges from 20 to 80, with 20 representing the most aggressive policing and 80 representing the most relaxed policing; and (3) the attack risk indicator ranges from 0 to 100, with 0 representing a lowest attack risk and 100 representing a highest attack risk.

Continuing with the example, upon commencement of operation of web gateway 130 (t₀), the attack risk indicator is initialized to 50, reflecting uncertainty about attack risk in the operating environment. As illustrated in FIG. 7, which shows the functional relationship between the attack risk indicator and the suspicion threshold in the present example, this initial setting causes the suspicion threshold to initialize to 50, such that inbound executable objects having suspicion values above 50 are initially detected by heuristic detection module 330 and subjected to policing actions (i.e. moderate policing). At a later time (t₁) after which numerous inbound executable objects have been processed by web gateway 130 without triggering any signature or heuristic detections, the attack risk indicator drops to about 30. This causes the suspicion threshold to rise to 70, such that inbound executable objects are less likely to be detected by heuristic detection module 330 and subjected to policing actions (i.e. relaxed policing). At an even later time (t₂), in the midst of a network attack in which inbound executable objects processed by web gateway 130 have triggered signature or heuristic detections, the attack risk indicator rises to about 90. This causes the suspicion threshold to fall to 20 such that inbound executable objects are more likely to be detected by heuristic detection module 330 and subjected to policing actions (i.e. aggressive policing).

FIG. 8 shows an endpoint security system 800 in alternative embodiments of the invention. These embodiments operate as in the previously described embodiments, except that web client 810 assumes the role of web gateway 130 to protect destination applications on web client 810 from malicious executable objects transmitted by a web content server 820. In providing this protection, a client processor on web client 810 intercepts an inbound executable object en route to a destination application on web client 810. A heuristic detection module executing on the client processor obtains a suspicion value for the executable object, if necessary by consulting a cloud server 830 that generates the suspicion value using heuristic behavioral scanning. The client processor compares the suspicion value with a suspicion threshold stored in a local memory on web client 810 to determine whether to subject the executable object to a policing action, such as discard, quarantine or alert, or allow the executable object to proceed to the destination application on web client 810. Web client 810 subjects the executable object to the policing action if the comparison indicates that the suspicion value violates the suspicion threshold and dynamically adjusts the suspicion threshold based on an outcome of processing the executable object. The suspicion threshold is dynamically adjusted by updating an attack risk indicator stored in a local memory on web client 810 based on the processing outcome and updating the suspicion threshold based on the updated attack risk indicator.

It will be appreciated by those of ordinary skill in the art that the invention can be embodied in other specific forms without departing from the spirit or essential character hereof. For example, in embodiments of the invention, heuristic behavioral scanning may be conducted on web gateway 130 or web client 810, avoiding the need to consult a cloud server. The present description is considered in all respects to be illustrative and not restrictive. The scope of the invention is indicated by the appended claims, and all changes that come within the meaning and range of equivalents thereof are intended to be embraced therein.

What is claimed is:

1. A computer-implemented executable object policing method, comprising:
receiving an executable object from a network;
obtaining a suspicion value for the executable object, wherein the suspicion value is generated based on heuristic behavioral scanning and represents a potential for maliciousness of the executable object;
comparing the suspicion value with a suspicion threshold;
subjecting the executable object to a policing action if the comparison indicates that the suspicion value violates the suspicion threshold; and
dynamically adjusting the suspicion threshold based on an outcome of processing the executable object.

2. The method of claim 1, wherein the dynamically adjusting step comprises updating an attack risk indicator based on the processing outcome and updating the suspicion threshold based on the attack risk indicator.

3. The method of claim 1, wherein the executable object is an executable file.

4. The method of claim 1, wherein the executable object is a web page containing executable script.

5. The method of claim 1, wherein the heuristic behavioral scanning comprises detecting suspicious operations performed by the executable object.

6. The method of claim 1, wherein the heuristic behavioral scanning comprises detecting suspicious program code structures in the executable object.

7. The method of claim 1, wherein the suspicion value and the suspicion threshold comprise numbers selected from a predetermined domain of at least three numbers.

8. The method of claim 1, wherein the suspicion value and the suspicion threshold comprise levels selected from a predetermined group of at least three levels.

9. The method of claim 1, wherein the suspicion value is obtained by subjecting the executable object to the heuristic behavioral scanning in real-time.

10. The method of claim 1, wherein the suspicion value is obtained by retrieving the suspicion value from a data store using a hash value for the executable object.

11. The method of claim 1, wherein the policing action comprises one or more of discarding the executable object, quarantining the executable object, logging a security event regarding the executable object or outputting a security alert regarding the executable object.

12. The method of claim 1, further comprising forwarding the executable object to a destination without subjecting the executable object to the policing action if the comparison indicates that the suspicion value does not violate the suspicion threshold.

13. A computing device, comprising:
a memory configured to store a suspicion threshold;
a network interface configured to receive an executable object; and
a processor communicatively coupled with the memory and the network interface and configured to obtain a suspicion value for the executable object, wherein the suspicion value is generated based on heuristic behavioral scanning and represents a potential for maliciousness of the executable object, wherein the processor is further configured to compare the suspicion value with the suspicion threshold and, if the comparison indicates the suspicion value violates the suspicion threshold, subject the executable object to a policing action, the processor being further configured to dynamically adjust the suspicion threshold based on an outcome of processing the executable object.

14. The computing device of claim 13, the suspicion threshold is dynamically adjusted by updating an attack risk indicator based on the processing outcome and updating the suspicion threshold based on the attack risk indicator.

15. The device of claim 13, wherein the computing device is a web gateway.

16. The device of claim 14, wherein the computing device is a web client.

17. An executable object policing system, comprising:
a first computing device configured to receive an executable object from a network, obtain a suspicion value for the executable object, wherein the suspicion value represents a potential for maliciousness of the executable object, compare the suspicion value with a suspicion threshold and, if the comparison indicates that suspicion value violates the suspicion threshold, subject the executable object to a policing action, the first computing device being further configured to dynamically adjust the suspicion threshold based on an outcome of processing the executable object; and
a second computing device communicatively coupled with the first computing device and configured to generate the suspicion value based on heuristic behavioral scanning and provide the suspicion value to the first computing device.

18. The system of claim 17, wherein the suspicion threshold is dynamically adjusted by updating an attack risk indicator based on the processing outcome and updating the suspicion threshold based on the attack risk indicator.

19. The system of claim 17, wherein the first computing device is a web gateway and the second computing device is a cloud server.

20. The system of claim 17, wherein the first computing device is a web client and the second computing device is a cloud server.
